(19) United States
(12) Patent Application Publication
(10) Pub. No.: US 2026/0112844 A1
(43) Pub. Date: Apr. 23, 2026

(54) CONNECTOR AND CONNECTING ASSEMBLY

(71) Applicant: Xuancheng Luxshare Precision Industry Co., Ltd., Xuancheng City (CN)

(72) Inventors: Yiqiang Bai, Xuancheng City (CN); Weihe Hong, Xuancheng City (CN)

(73) Assignee: Xuancheng Luxshare Precision Industry Co., Ltd., Xuancheng City (CN)

(21) Appl. No.: 19/358,802

(22) Filed: Oct. 15, 2025

(30) Foreign Application Priority Data
Oct. 18, 2024 (CN) 202411465059.8

(51) Int. Cl. H01R 13/631

(52) U.S. Cl. CPC H01R 13/631

(57) ABSTRACT

Provided are a connector and a connecting assembly. The connector includes a connector body and a knob. The connector body includes a mounting hole and two locking bars. When the connector and a cooperating connector are docked, two locking bars move to the locked position and are engaged with two lock catches of the cooperating connector. When the locking bars move to the unlocked position, the locking bars are separated from the corresponding lock catches. The knob is rotatably arranged in the mounting hole and includes a fastening member arranged between the two locking bars. The knob turns between a fastening position and an unfastening position, and the knob controls the fastening member rotatably pushes against at least one of the two locking bars. The two locking bars of the connector are synchronously locked through the knob.

### CROSS-REFERENCE TO RELATED APPLICATION

This application claims the benefit of Chinese Patent Application No. 202411465059.8, filed on October 18, 2024, entitled “Connector and Connecting Assembly”, which is incorporated herein by reference in its entirety.

### FIELD

The present disclosure relates to a connector and a connecting assembly.

### BACKGROUND

Connector is widely used in various fields for transmitting electrical signals, optical signals, and like. To ensure safety and reliability of the signal transmission, the connector typically has a locking mechanism. However, the locking structure of existing connectors is prone to separation, resulting a poor connection reliability.

### SUMMARY

In view of the above, the present disclosure aims to provide a connector and a connecting assembly.

According to one aspect of embodiments of the present disclosure, a connector is provided. The connector includes: a connector body and a knob. The connector body is provided with a mounting hole and two locking bars. Each locking bar is configured to swing between a locked position and an unlocked position. The two locking bars are in the locked position and engaged with two lock catches of a cooperating connector when the connector is docked to the cooperating connector, and the two locking bars are separated from the two lock catches of the cooperating connector when the two locking bars are in the unlocked position. The knob is rotatably arranged in the mounting hole and includes a fastening member, and the fastening member is arranged between the two locking bars. The knob is configured to turn between a fastening position and an unfastening position, and the knob controls the fastening member rotatably pushes against at least one of the two locking bars.

According to another aspect of embodiments of the present disclosure, a connecting assembly is provided. The connecting assembly includes the connector in the first aspect, and cooperating connector. The cooperating connector is provided with two lock catches protruding from the cooperating connector, the two lock catches are respectively engaged with the two locking bars when the connector is docked to the cooperating connector.

### BRIEF DESCRIPTION OF THE DRAWINGS

The various features and advantages of the disclosed examples will become apparent to those skilled in the art from the detailed description. The figures that accompany the detailed description can be briefly described as follows:

FIG. 1 is a structural view of a connector provided by embodiments of the present disclosure;

FIG. 2 is a structural view of the connector from another perspective provided by embodiments of the present disclosure;

FIG. 3 is a structural view of a connector body provided by embodiments of the present disclosure;

FIG. 4 is a structural view of a connector docked to a cooperating connector provided by embodiments of the present disclosure;

FIG. 5 is a structural view of a cooperating connector provided by embodiments of the present disclosure;

FIG. 6 is a structural view of a knob provided by embodiments of the present disclosure;

FIG. 7 is a schematic view showing a connector and a cooperating connector before being docked provided by embodiments of the present disclosure;

FIG. 8 is a sectional view of the connector and the cooperating connector before being docked provided by embodiments of the present disclosure;

FIG. 9 is a sectional view of the connector and the cooperating connector after being docked provided by embodiments of the present disclosure;

FIG. 10 is a schematic view when a knob is in a fastening position provided by embodiments of the present disclosure;

FIG. 11 is a sectional view when the knob is in the fastening position provided by embodiments of the present disclosure;

FIG. 12 is an enlarged partial view of a mounting hole provided by embodiments of the present disclosure; and

FIG. 13 is a sectional view when the knob is in an unfastening position provided by embodiments of the present disclosure.

### LIST OF REFERENCE SIGNS

1: connector body; 11: mounting hole; 111: annular protrusion;

1111: first inclined surface; 112: second gap;

113: arc-shaped protrusion; 1131: first slop surface;

1132: second slop surface; 12: locking bar; 121: pivot member;

122: bar body; 1221: first bar body segment; 12211: chamfer;

1222: second bar body segment; 12221: convex part;

123: engaging member; 1231: third slop surface;

13: docking slot; 131: expansion slot; 132: operation hole;

133: notch; 2: knob; 21: fastening member; 22: knob body;

221: annular recess; 2211: second inclined surface; 222: first gap;

223: stopping member; 23: driving member; 24: connecting member;

A: connector; B: cooperating connector;

B1: lock catch; B11: fourth slop surface.

### DETAILED DESCRIPTION OF EMBODIMENTS

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, it should be understood by those skilled in the art, the drawings herein are provided for the purpose of illustration, and the drawings are not necessarily to scale.

Unless otherwise stated or defined, the terms "install", "connected", "connect", "fix" and the like should be understood in a broad sense, for example, the term "connected" may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

Further, spatially relative terms, such as “inside”, “outside”, “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Unless otherwise stated, the terms “comprise”, “include” and the like in the entire application document shall be interpreted as inclusive rather than exclusive or exhaustive; in other words, the terms mean "include but not limited to".

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

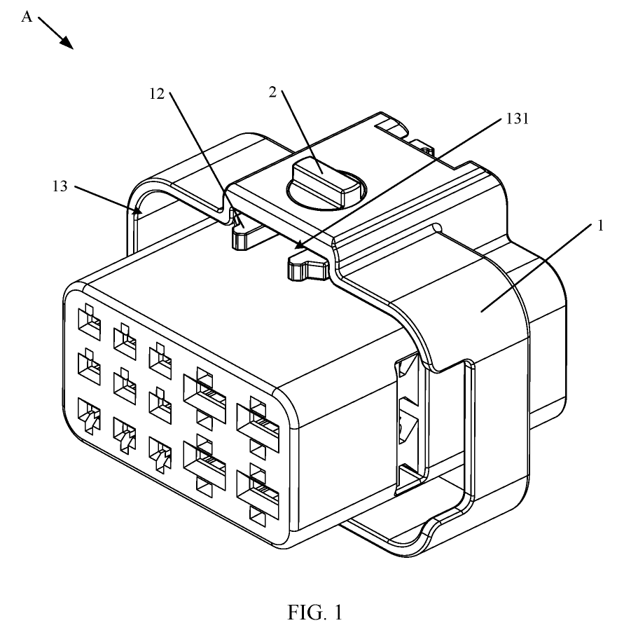

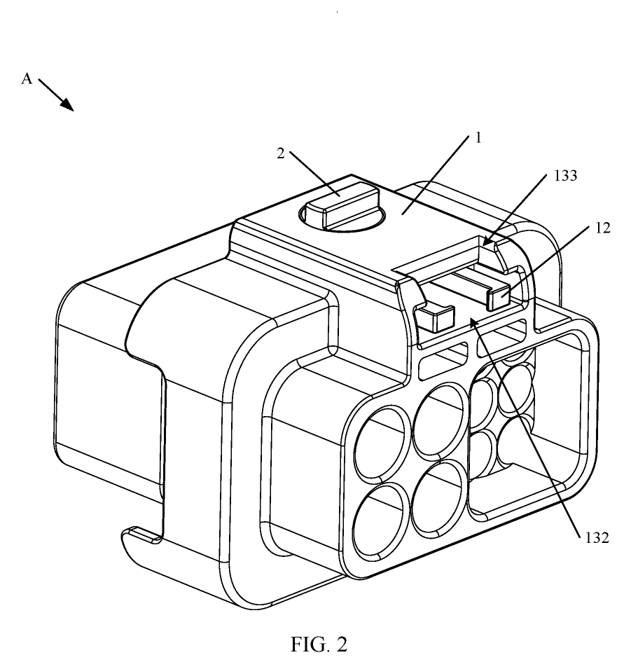

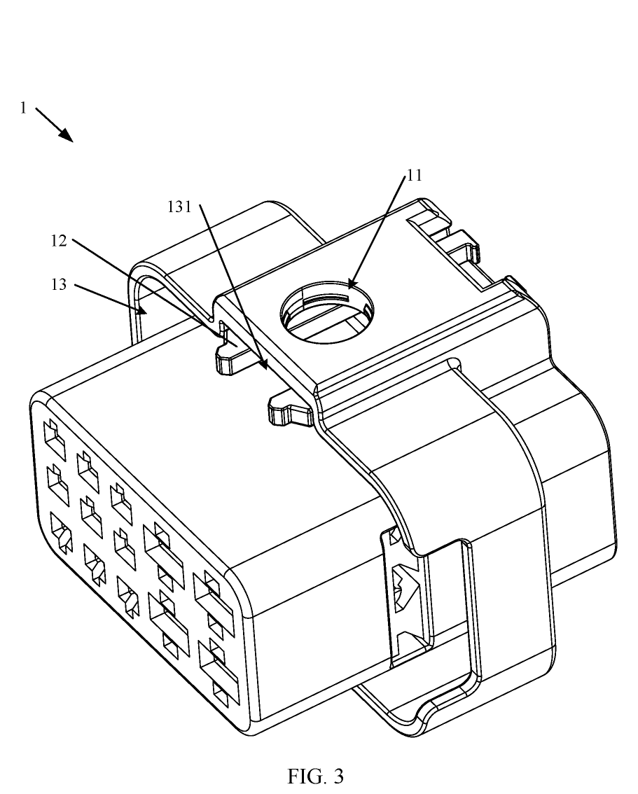

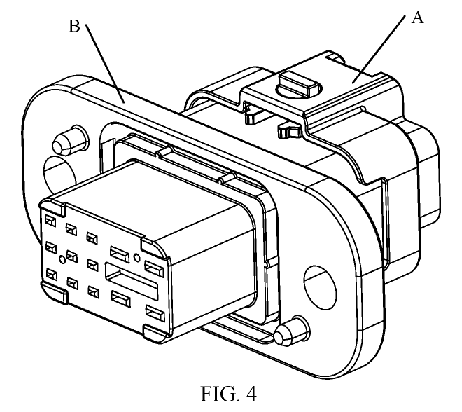

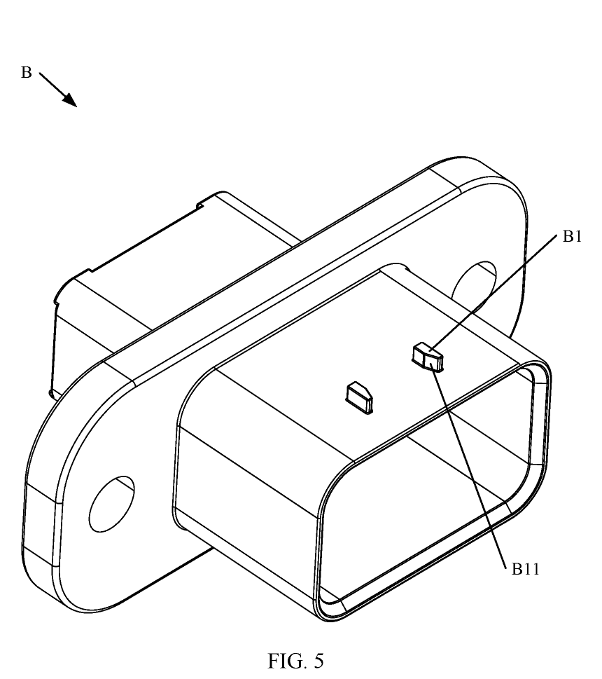

FIG. 1 is a structural view of a connector provided by embodiments of the present disclosure. FIG. 2 is a structural view of the connector from another perspective provided by embodiments of the present disclosure. As shown in FIG. 1 and FIG. 2, a connector A includes a connector body 1 and a knob 2. FIG. 3 is a structural view of a connector body provided by embodiments of the present disclosure. As shown in FIG. 3, the connector body 1 is provided with a mounting hole 11 and two locking bars 12. For example, the locking bar 12 is configured to swing between a locked position and an unlocked position. It should be noted that when the locking bar 12 is at the locked position, the two locking bars 12 are in an initial state and parallel to each other. Correspondingly, when the locking bars 12 are at the unlocked position, the locking bars 12 are deflected toward each other. FIG. 4 is a structural view of a connector docked to a cooperating connector provided by embodiments of the present disclosure. FIG. 5 is a structural view of a cooperating connector provided by embodiments of the present disclosure. As shown in FIG. 1 to FIG. 5, when the connector A is docked to (for example, plugged in) the cooperating connector B, the two locking bars 12 are at the locked position and are respectively engaged with (fastened to) two lock catches B1 of the cooperating connector B. For example, the two locking bars 12 are respectively engaged with two lock catches B1 in a snap-fit manner. When the locking bars 12 are at the unlocked position, the locking bars 12 are separated from the corresponding lock catches B1. For example, the locking bar 12 moves in relation to the lock catch B1 along the plug-in direction of the connector A, such that the locking bar 12 and the lock catch B1 are separated.

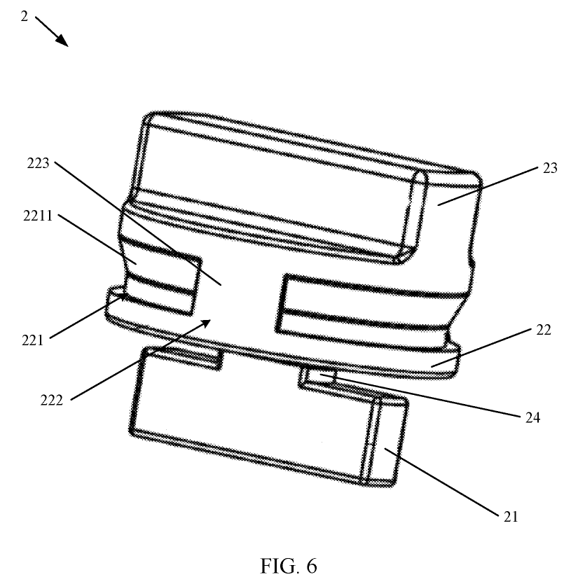

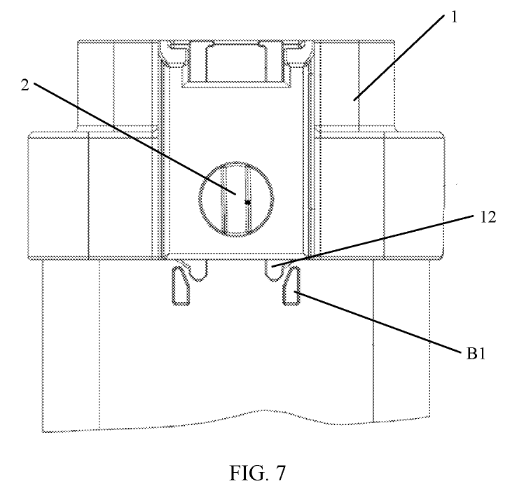

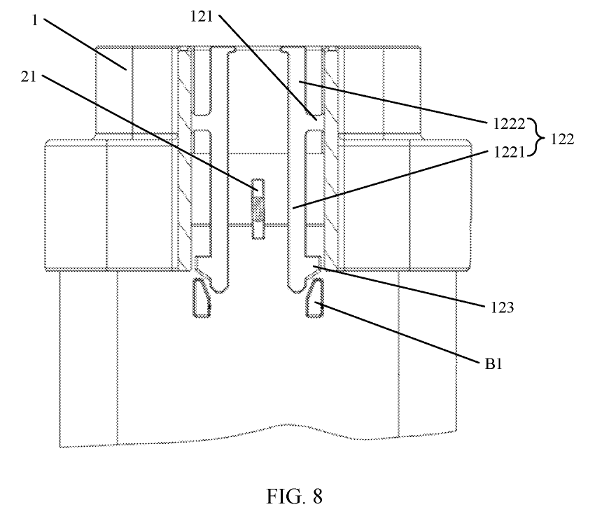

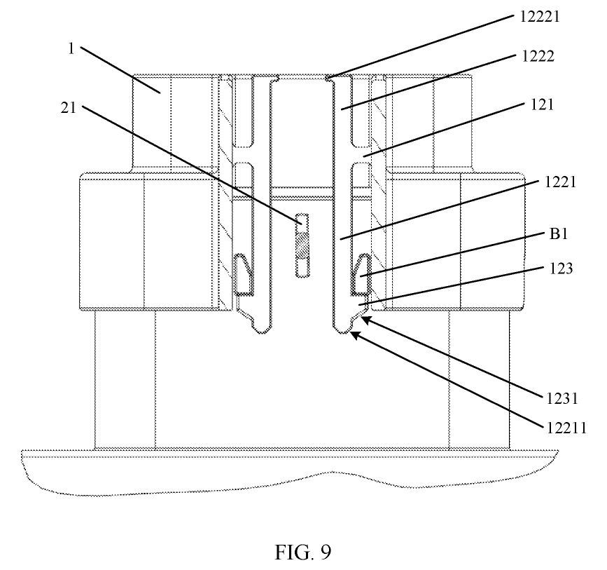

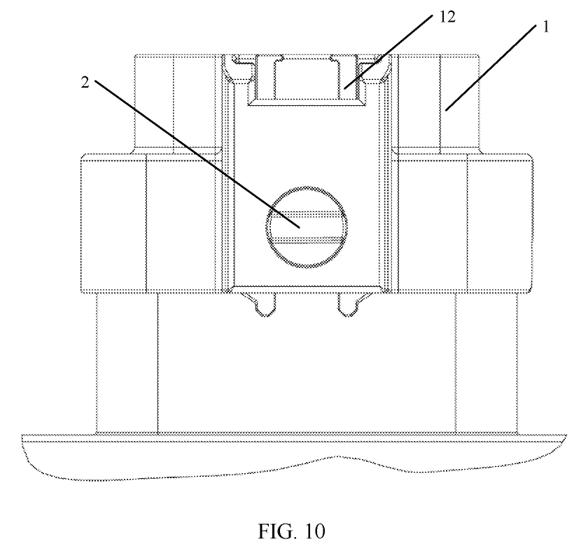

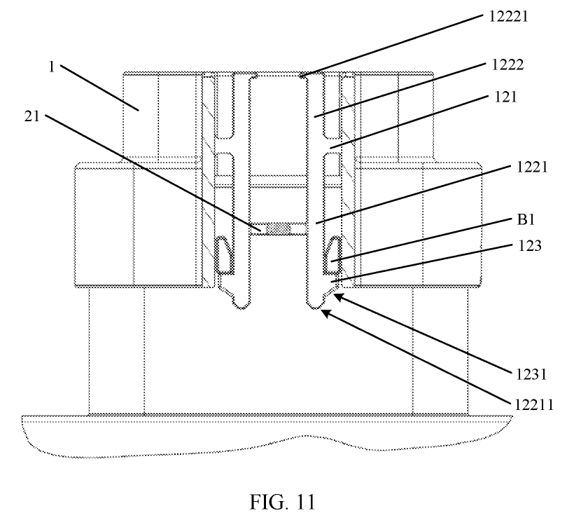

FIG. 6 is a structural view of a knob provided by embodiments of the present disclosure. As shown in FIG. 6, the knob 2 includes a fastening member 21. FIG. 7 is a schematic view showing a connector and a cooperating connector before being docked provided by embodiments of the present disclosure. FIG. 8 is a sectional view of the connector and the cooperating connector before being docked provided by embodiments of the present disclosure. FIG. 9 is a sectional view of the connector and the cooperating connector after being docked provided by embodiments of the present disclosure. FIG. 10 is a schematic view when a knob is in a fastening position provided by embodiments of the present disclosure. FIG. 11 is a sectional view when the knob is in the fastening position provided by embodiments of the present disclosure. As shown in FIG. 7 to FIG. 11, the knob 2 is rotatably arranged in the mounting hole 11 and is configured to turn between a fastening position and an unfastening position. The fastening member 21 is arranged between the two locking bars 12. When the knob 2 turns to the fastening position, the knob 2 drives the fastening member 21 to rotate to a place for synchronously pushing against the two locking bars 12. When the knob 2 turns to the unfastening position, the knob 2 drives the fastening member 21 to rotate to a place for synchronously being separated from the two locking bars 12. It is noted that when the two locking bars 12 are respectively fastened to the two lock catches B1, two ends of the fastening member 21 synchronously apply to the two lock catches B1 respectively. Even the two locking bars 12 have a tendency of deflecting towards the unlocked position, the two locking bars 12 are limited by action of the fastening member 21, and the locking mechanism realizes self-locking, thereby the connection reliability is improved when the connector A and the cooperating connector B are fastened. When the connector A is not docked to the cooperating connector B, the knob 2 turns and causes the fastening member 21 to synchronously press the two locking bars 12, such that the locking bars 12 cannot deflect to the unlocked position and cannot be fastened to the lock catch B1, thereby preventing the connector A and the cooperating connector B from being fastened.

In some embodiments, the connector A includes one locking bar 12. The knob 2 controls one locking bar 12 and one lock catch B1 to be fastened to each other, and the fastening reliability between the connector A and the cooperating connector B is improved.

In some embodiments, as shown in FIG. 6, the knob 2 further includes a knob body 22 and a driving member 23. For example, the knob body 22 matches with the mounting hole 11 and is rotatably arranged in the mounting hole 11, and the fastening member 21 is arranged at an end of the knob body 22 facing the locking bar 12. It is noted that when the mounting hole 11 is a circular hole, the knob body 22 is a cylindrical structure, so the knob 2 can rotate in the mounting hole 11. The driving member 23 is arranged at an end of the knob body 22 away from the fastening member 21. An operator turns the driving member 23 causing the knob body 22 and the fastening member 21 to rotate, and at hence the fastening member 21 presses the locking bar 12 or is separated from the locking bar 12.

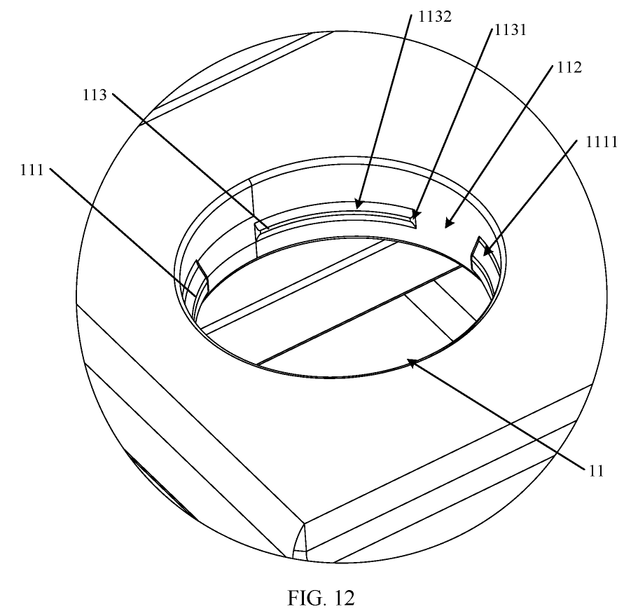

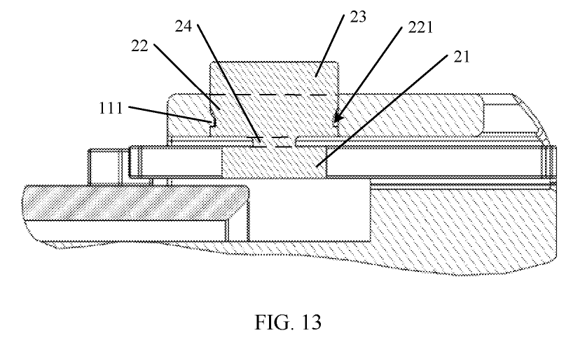

FIG. 12 is an enlarged partial view of a mounting hole provided by embodiments of the present disclosure. In some embodiments, as shown in FIG. 12, an inner wall of the mounting hole 11 is provided with an annular protrusion 111. FIG. 13 is a sectional view when the knob is at an unfastening position provided by embodiments of the present disclosure. As shown in FIG. 6, FIG. 12 and FIG. 13, a side surface of the knob body 22 is provided with an annular recess 221 matching with the annular protrusion 111, and the annular recess 221 is configured to accommodating the annular protrusion 111. It is noted that the annular protrusion 111 is arranged in the annular recess 221 such that the knob 2 is mounted in the mounting hole 11. When the knob 2 turns between the fastening position and the unfastening position, the annular protrusion 111 moves in the annular recess 221.

In some embodiments, as shown in FIG. 6, the annular recess 221 is arranged occupying 330° to form a first gap 222. For example, the annular recess 221 is arc-shaped, and the arc angle is 330°. As shown in FIG. 12, the annular protrusion 111 is arranged occupying 240° to form a second gap 112. It is noted that when the knob 2 turns between the fastening position and the unfastening position, the annular protrusion 111 moves in the annular recess 221, and the motion range is 90°. That is, the knob 2 reaches the unfastening position by turning 90° from the fastening position. Accordingly, the knob 2 reaches the fastening position by turning 90° from the unfastening position. Through rotation of 90°, the fastening member 21 is completely separated from the locking bar 12 or effectively pushes the locking bar 12.

In some embodiments, as shown in FIG. 6, the knob body 22 is provided with a stopping member 223 at the first gap 222. The first gap 222 (that is, the stopping member 223) is arranged occupying 90°. Correspondingly, the second gap 112 is arranged occupying 120°. The stopping member 223 moves in the second gap 112. When the knob 2 turns to the fastening position or the unfastening position, the stopping member 223 abuts against an end of the annular protrusion 111. In this way, the knob 2 turns to the desired position, and the turning of the knob 2 is limited.

In some embodiments, as shown in FIG. 12, a middle position of the second gap 112 protrudes to form an arc-shaped protrusion 113. The arc-shaped protrusion 113 is arranged occupying 60°. When the knob 2 is at the fastening position or the unfastening position, the stopping member 223 is not in contact with the arc-shaped protrusion 113, and the arc-shaped protrusion 113 limits the stopping member 223, so the position of the knob 2 is fixed. It is noted that the protruding degree of the arc-shaped protrusion 113 is small. Therefore, when the knob 2 turns from the fastening position to the unfastening position or turns from the unfastening position to the fastening position, the stopping member 223 may press the arc-shaped protrusion 113 and rotate. The arc-shaped protrusion 113 causes a resistance force to the knob 2, and the operator manipulating the knob 2 can feel the resistance force.

In some embodiments, as shown in FIG. 12, the arc-shaped protrusion 113 has two ends, and each end is provided with a first slop surface 1131. When the knob 2 turns from the fastening position to the unfastening position or turns from the unfastening position to the fastening position, the stopping member 223 slides along the first slop surface 1131 and further slides to the top surface of the arc-shaped protrusion 113, thereby reducing the resistance force during turning the knob 2.

In some embodiments, as shown in FIG. 12, the arc-shaped protrusion 113 has two sides, and each side is provided with a second slop surface 1132. The turning of the knob 2 causes the stopping member 223 slides on the arc-shaped protrusion 113. The contact area between the stopping member 223 and the arc-shaped protrusion 113 is small. Therefore, the turning smoothness of the knob 2 is improved.

In some embodiments, as shown in FIG. 12, the annular protrusion 111 is provided with a first inclined surface 1111, and the annular recess 221 is provided with a second inclined surface 2211 matching with the first inclined surface 1111. The first inclined surface 1111 of the annular protrusion 111 is in contact with the second inclined surface 2211 of the annular recess 221, so the turning smoothness of the knob 2 is improved.

In some embodiments, as shown in FIG. 6, each of the driving member 23 and the fastening member 21 is a rod structure. With the rod-structured driving member 23, the operator easily and conveniently turns the knob 2. Due to the rod structure of the fastening member 21, the fastening member 21 synchronously presses or is separated from the locking bar 12 with a better effect. The driving member 23 and the fastening member 21 are parallel to each other. Therefore, when the operator turns the knob 2 through the driving member 23, the operator knows the current position of the fastening member 21.

In some embodiments, as shown in FIG. 6, the knob 2 further includes a connecting member 24. For example, the connecting member 24 is connected to both the knob body 22 and the fastening member 21. It is noted that the distance between the fastening member 21 and the knob body 22 may be adjusted by the connecting member 24 of the knob 2, and thus the fastening member 21 and the locking bar 12 are kept in the same plane, thereby ensuring that the fastening member 21 can press the locking bar 12.

In some embodiments, as shown in FIG. 8, FIG. 9, and FIG. 11, the locking bar 12 includes a pivot member 121, a bar body 122, and an engaging member 123. For example, the pivot member 121 protrudes from a preset position of the connector body 1. The bar body 122 is a rod structure and connected to the pivot member 121. The bar body 122 includes a first bar body segment 1221 and a second bar body segment 1222, and the boundary between the first bar body segment 1221 and the second bar body segment 1222 is defined by the pivot member 121. The engaging member 123 is arranged at an end of the first bar body segment 1221 and is configured to be engaged with the corresponding lock catch B1. The bar body 122 is a lever structure, and the pivot point of the lever structure is the pivot member 121. Therefore, the locking bar 12 can swing between the locked position and the unlocked position. In some embodiments, a part of the bar body 122 connecting the pivot member 121 has sufficient flexibility. It is noted that the engaging member 123 protrudes from the first bar body segment 1221 towards the direction away from the fastening member 21.

In some embodiments, as shown in FIG. 8, FIG. 9, and FIG. 11, a length of the first bar body segment 1221 is greater than a length of the second bar body segment 1222. When the lock catch B1 applies a force to an end of the first bar body segment 1221 and the force causes deflection of the locking bar 12, it just needs to apply a small force to the locking bar 12 to cause the locking bar 12 to move to the unlocked position for subsequent engaging with the lock catch B1. On the other hand, when the operator applies a force to the second bar body segment 1222 causing deflection of the locking bar 12, the operator needs to apply an enough force to ensure the engagement between the locking bar 12 and the lock catch B1 and ensure the connection reliability between the connector A and the cooperating connector B. In some embodiments, the length of the first bar body segment 1221 is twice of the length of the second bar body segment 1222.

In some embodiments, as shown in FIG. 9 and FIG. 10, an end of the engaging member 123 facing the cooperating connector B is provided with a third slop surface 1231. In the docking process of the connector A and the cooperating connector B, the third slop surface 1231 of the engaging member 123 firstly contacts with the lock catch B1, the lock catch B1 applies a force to the engaging member 123 causing the engaging member 123 to deflect, the deflection of the engaging member 123 drives the locking bar 12 to deflect towards the unlocked position, and thus the locking bar 12 and the lock catch B1 are engaged automatically.

In some embodiments, as shown in FIG. 9 and FIG. 11, an end of the first bar body segment 1221 is provided with a chamfer 12211. The chamfer 12211 prevents damage cause by collision between the locking bar 12 and the lock catch B1, and provides motion guiding for the deflection of the locking bar 12.

In some embodiments, as shown in FIG. 9 and FIG. 11, an end of the second bar body segment 1221 protrudes to form a convex part 12221. When the operator unlocks the locking bar 12 from the lock catch B1, the operator applies a force to the second bar body segment 1222 to cause deflection of the locking bar 12. The force is applied to the convex part 12221 ensuring that the successful operation. In addition, the convex part 12221 also provides a stopping function.

In some embodiments, as shown in FIG. 1 and FIG. 3, a side of the connector body 1 facing the cooperating connector B is recessed to form a docking slot 13. The docking slot 13 matches with the cooperating connector B such that the connector A can be docked to the cooperating connector B. The sidewall of the docking slot 13 extends outwards to form an expansion slot 131. The expansion slot 131 accommodates the locking bars 12. The fastening member 21 extends into the expansion slot 131. As a result, the structure of the connector A is more compact, the fastening member 21 and the locking bar 12 do not occupy additional space, and the assembling of the connector A and the cooperating connector B is more reliable.

In some embodiments, as shown in FIG. 2, the slot bottom of the expansion slot 131 is formed with an operation hole 132. The locking bar 12 passes the operation hole 132. Therefore, the operator can conveniently apply a force to the locking bar 12 through the operation hole 132 for releasing the locking bar 12. In some embodiments, the operation hole 132 is provided with a notch 133. With the notch 133, the operator has larger operation space, and it is more convenient for the operator to apply a force to the locking bar 12 with a tool or in another manner.

Embodiments of the present disclosure further provide a connecting assembly. The connecting assembly includes a connector A and a cooperating connector B. For example, the connector A is a plug, and the cooperating connector B is a socket. Details of the connector A have been described above and are not repeated here. The cooperating connector B includes two lock catches B1 protruding from the cooperating connector B. When the cooperating connector B and the connector A are docked, two lock catches B1 are engaged with two locking bars 12 respectively. By turning the knob of the connector A, the two locking bars 12 are synchronously locked. Therefore, the connection reliability between the cooperating connector B and the connector A is improved, and the locking bar 12 is blocked when the connector A is not docked to the cooperating connector B avoiding docking error.

In some embodiments, as shown in FIG. 5, an end of the lock catch B1 facing the connector A is provided with a fourth slop surface B11. When the connector A is docked to the locking bar 12, the engaging member 123 of the locking bar 12 moves along the fourth slop surface B11 so as to drive the locking bar 12 to deflect.

Embodiments of the present disclosure provide a connector and a connecting assembly. The connector includes a connector body and a knob. The connector body includes a mounting hole and two locking bars. When the connector and a cooperating connector are docked, two locking bars move to the locked position and are engaged with two lock catches of the cooperating connector. When the locking bars move to the unlocked position, the locking bars are separated from the corresponding lock catches. The knob is rotatably arranged in the mounting hole and includes a fastening member arranged between the two locking bars. The knob turns between a fastening position and an unfastening position, and the knob controls the fastening member rotatably pushes against at least one of the two locking bars. The two locking bars of the connector are synchronously locked through the knob. The connection reliability is improved when the connector is docked to the cooperating connector. When the connector is not docked to any cooperating connector, the locking bars are locked to avoid connection mistake of the connector.

The above embodiments are exemplary embodiments of the present disclosure and are not intended to limit the present disclosure. The present disclosure may be subject to various modifications and variations to those skilled in the art. Any modifications, equivalent substitutions or improvements that are within the spirit and principle of the disclosure are intended to be covered by the protection scope of the disclosure.

I/We claim:

1. A connector, comprising:
a connector body, wherein the connector body is provided with a mounting hole and two locking bars, each locking bar is configured to swing between a locked position and an unlocked position, wherein the two locking bars are in the locked position and engaged with two lock catches of a cooperating connector when the connector is docked to the cooperating connector, and the two locking bars are separated from the two lock catches of the cooperating connector when the two locking bars are in the unlocked position; and
a knob, wherein the knob is rotatably arranged in the mounting hole and comprises a fastening member, the fastening member is arranged between the two locking bars, the knob is configured to turn between a fastening position and an unfastening position, and the knob controls the fastening member rotatably pushes against at least one of the two locking bars.

2. The connector according to claim 1, wherein the fastening member synchronously presses the two locking bars when the knob is in the fastening position, and the fastening member is synchronously separated from the two locking bars when the knob is in the unfastening position.

3. The connector according to claim 1, wherein the knob further comprises a knob body and a driving member,
the knob body matches with the mounting hole and is rotatably arranged in the mounting hole, and the fastening member is arranged at an end of the knob body facing the locking bar, and
the driving member is arranged at an end of the knob body away from the fastening member.

4. The connector according to claim 3, wherein an inner wall of the mounting hole is provided with an annular protrusion, and a side surface of the knob body is provided with an annular recess matching with the annular protrusion and configured to accommodating the annular protrusion.

5. The connector according to claim 4, wherein the annular recess is arranged occupying 330° to form a first gap, and the annular protrusion is arranged occupying 240° to form a second gap.

6. The connector according to claim 5, wherein the knob body is provided with a stopping member at the first gap, and the stopping member moves in the second gap.

7. The connector according to claim 6, wherein a middle position of the second gap protrudes to form an arc-shaped protrusion, and the arc-shaped protrusion is arranged occupying 60°.

8. The connector according to claim 7, wherein each of two ends of the arc-shaped protrusion is provided with a first slop surface.

9. The connector according to claim 7, wherein each of two sides of the arc-shaped protrusion is provided with a second slop surface.

10. The connector according to claim 4, wherein the annular protrusion is provided with a first inclined surface, and the annular recess is provided with a second inclined surface matching with the first inclined surface.

11. The connector according to claim 3, wherein each of the driving member and the fastening member is a rod structure, and the driving member and the fastening member are parallel to each other.

12. The connector according to claim 3, wherein the knob further comprises a connecting member connected to both the knob body and the fastening member.

13. The connector according to claim 1, wherein each locking bar comprises a pivot member, a bar body, and an engaging member, the pivot member protrudes from a preset position of the connector body, the bar body is a rod structure and connected to the pivot member, and the bar body comprises a first bar body segment and a second bar body segment defined by the pivot member, and the engaging member is arranged at an end of the first bar body segment and is configured to be engaged with the corresponding lock catch.

14. The connector according to claim 13, wherein a length of the first bar body segment is greater than a length of the second bar body segment.

15. The connector according to claim 13, wherein an end of the engaging member facing the cooperating connector is provided with a third slop surface.

16. The connector according to claim 13, wherein an end of the first bar body segment is provided with a chamfer.

17. The connector according to claim 13, wherein an end of the second bar body segment protrudes to form a convex part.

18. The connector according to claim 1, wherein the connector body is provided with an operation hole for exposing the locking bar.

19. The connector according to claim 18, wherein the operation hole is provided with a notch.

20. A connecting assembly, comprising:
a connector; and
a cooperating connector,
wherein the cooperating connector is provided with two lock catches protruding from the cooperating connector,
wherein the connector comprises: a connector body and a knob,
the connector body is provided with a mounting hole and two locking bars, each locking bar is configured to swing between a locked position and an unlocked position, the two locking bars are in the locked position and engaged with two lock catches of a cooperating connector when the connector is docked to the cooperating connector, and the two locking bars are separated from the two lock catches of the cooperating connector when the two locking bars are in the unlocked position,
the knob is rotatably arranged in the mounting hole and comprises a fastening member, the fastening member is arranged between the two locking bars, the knob is configured to turn between a fastening position and an unfastening position, and the knob controls the fastening member rotatably pushes against at least one of the two locking bars,
wherein an end of the lock catch facing the connector is provided with a fourth slop surface.
